(19) United States
(12) Patent Application Publication
(10) Pub. No.: US 2023/0417321 A1
(43) Pub. Date: Dec. 28, 2023

(54) VEHICLE SHIFTING MECHANISM

(71) Applicants: KUO-HSIN SU, NEW TAIPEI CITY (TW); TA-YU SU, NEW TAIPEI CITY (TW); HSUN-I LEE, NEW TAIPEI CITY (TW)

(72) Inventors: KUO-HSIN SU, NEW TAIPEI CITY (TW); TA-YU SU, NEW TAIPEI CITY (TW); HSUN-I LEE, NEW TAIPEI CITY (TW)

(21) Appl. No.: 17/846,699

(22) Filed: Jun. 22, 2022

(51) Int. Cl. F16H 61/32; F16H 59/02; F16H 59/74; F16H 59/14

(52) U.S. Cl. CPC F16H 61/32; F16H 59/0278; F16H 59/0217; F16H 59/74; F16H 59/14

(57) ABSTRACT

A vehicle shifting mechanism includes a gearbox, a shift drive unit and a gearshift lever. Through electrical connection between a control switch and the shift drive unit, the operation of controlling the forward or reverse gear is carried out, so that the shift drive unit drives the gearshift lever to produce the action of pushing down the gear or pushing up the gear. Through an automatic shift switch and in cooperation with a main driving control processor, when the automatic shift switch is turned into automatic shift mode, the main driving control processor receives the data of the main power motor or the engine speed and torque load of the vehicle to activate the shift drive unit to drive the gearshift lever to generate a fully automatic downshifting gear or an upshifting gear and a neutral gear control.

### BACKGROUND OF THE INVENTION

### 1. Field of the Invention

The present invention relates to gear shift technology, in particular, refers to a vehicle shifting mechanism so configured that through the set control switch and automatic shift switch with a shift drive unit, the gearshift lever can be pressed down to advance or pushed up to reverse the action control and automatic shift mode.

### 2. Description of the Related Art

As we all know, because the motorcycle has a gearbox, shifting gears can be performed when starting with high power or when climbing hills and other road conditions to meet the required power, which can greatly save energy. When the conventional vehicle 6 needs to change the speed of the vehicle, as shown in the FIG. 12, by stepping on or reversing the gearshift lever 61, the gears can be changed to achieve the purpose of shifting. But when you need to switch back to the previous gear, you need to hook the gearshift lever 61 up with the instep to achieve the purpose of returning to the previous gear. But when the driver wears high-grade and expensive shoes, when the instep hooks the gearshift lever 61, the surface of the shoe will be scratched and damaged by the gearshift lever 61. If you usually wear thick shoes or rain boots, shoe covers, etc. in rainy days, it will also affect the normal operation when the gearshift lever 61 is hooked up to return to the previous gear.

In addition, in a general motorcycle, because the gearshift lever 61 needs to be used to shift the gears into and out of gear, there are still many people who are unable to drive a motorcycle because they are unfamiliar with shifting gears. In addition, when there are many traffic jams in urban areas, or when going uphill or downhill in the mountains, the driver needs to pay attention to the driving conditions while driving, and also need to constantly change gears depending on the driving needs. In the rush, the complexity and danger of driving operations are caused.

### SUMMARY OF THE INVENTION

The present invention has been accomplished under the circumstances in view. It is therefore the main object of the present invention to provide a vehicle shifting mechanism, which comprises a gearbox, a shift drive unit and a gearshift lever. The gearshift lever is located on the gearshift shaft of the gearbox. The shift drive unit is arranged on one side of the gearshift lever. Through the electrical connection between a control switch located beside the grip of the vehicle and the shift drive unit, the operation of controlling the forward or reverse gear is carried out, so that the shift drive unit drives the gearshift lever to produce the action of pushing down the gear or pushing up the gear. Through an automatic shift switch located beside the grip of the vehicle, and in cooperation with a main driving control processor, when the automatic shift switch is turned on to be in automatic shift mode, the main driving control processor receives the data of the main power motor or the engine speed and torque load of the vehicle to activate the shift drive unit at the optimum time point to drive the gearshift lever to generate a fully automatic downshifting gear or an upshifting gear and a neutral gear control, thereby achieving the purpose of changing gears more conveniently, improving driving safety and saving energy when driving.

Preferably, the shift drive unit comprises a motor, a speed reducer and a cam. The motor is set at an input end of the speed reducer. The speed reducer comprises a casing, and a first reduction gear and a second reduction gear provided in the casing. The motor is used to drive the first reduction gear. The second reduction gear comprises a power take-off shaft extending out from one side of the casing. A circuit board with a micro-motion sensing element is assembled on one side of the casing, and the second reduction gear and the circuit board are enclosed in the casing by a side cover and a gasket. The cam is provided on the power take-off shaft of the second reduction gear. When the motor drives the first reduction gear and the second reduction gear to rotate, the motor also drives the cam to rotate forward or reverse 360 degrees to drive the gearshift lever to produce the action of pressing down the forward gear or pushing up the reverse gear. By means of the magnetic element or a convex part on a hub of the second reduction gear and the micro-motion sensing element to generate sensing or pressure contact, and then after the cam rotates forward or reverse 360 degrees, the motor is stopped to make the cam stop at the original position.

Preferably, the shift drive unit is locked to the gearbox side cover for easy maintenance or replacement of the shift drive unit.

Preferably, the micro-motion sensing element is a sensing chip or a micro switch, and outside the gearbox side cover, there is an outer cover, which is beautiful and anti-fouling.

<Effects Compared to the Prior Art>

The main purpose of the present invention is to control the shift drive unit to perform forward shifting, backward shifting and automatic shifting operations. With the built-in algorithm of the main driving control processor, according to the actual load condition of the vehicle, it switches to the most appropriate gear at the best shifting timing in real time, so as to save energy and increase the cruising range of the vehicle. And there is no need to change gears by stepping on or hooking up the gearshift lever, thereby improving the safety of driving.

The second purpose of the present invention is mainly the design of the present invention, in addition to those who are generally familiar with gear shift vehicles, those who could not drive gear shift vehicles can also easily drive gear shift vehicles and experience the fun of gear shift vehicles.

Another purpose of the present invention is to control the shift drive unit by means of the provided control switch and the automatic shift switch. In addition to the traditional foot control for shifting, the control switch provided at the proper position of the grip can be used for manual shifting or switching to automatic shift.

Through the shift drive unit, the gear shift vehicle can be controlled by foot to change gears or controlled by the control switch and the automatic shift switch to control the shift drive unit to perform forward shifting, backward shifting and automatic shifting, thereby improving the driving pleasure and economic value of the gear shift vehicle.

### BRIEF DESCRIPTION OF THE DRAWINGS

FIG. 1 is an exploded perspective view of a preferred embodiment of the present invention.

FIG. 2 is a combined perspective view of the structure shown in FIG. 1.

FIG. 3 is a side view of the shift drive unit and gearshift lever of the present invention.

FIG. 4 to FIG. 4-3 show cam reverse rotation 360 degrees to complete the continuous action of pressing the gearshift lever once.

FIG. 5 to FIG. 5-3 show cam forward rotation 360 degrees to complete the continuous action of pushing up the gearshift lever once.

FIG. 6 is a perspective view of an embodiment of the present invention when it is actually used on a vehicle.

FIG. 7 is an enlarged view of an embodiment of the present invention where the vehicle grip is provided with a control switch for forward and reverse gears and an automatic shift switch.

FIG. 8 is an exploded perspective view of the shift drive unit of the present invention.

FIG. 9 is a perspective view of an embodiment of the present invention in which an outer cover is provided on the outside of the gearbox side cover.

FIG. 10 is a perspective view of an embodiment of the present invention when applied to an electric vehicle.

FIG. 11 is a perspective view of an embodiment of the present invention applied to the gear lever portion of an electric vehicle.

FIG. 12 is a perspective view of a conventional vehicle.

### DETAILED DESCRIPTION OF THE PREFERRED EMBODIMENTS

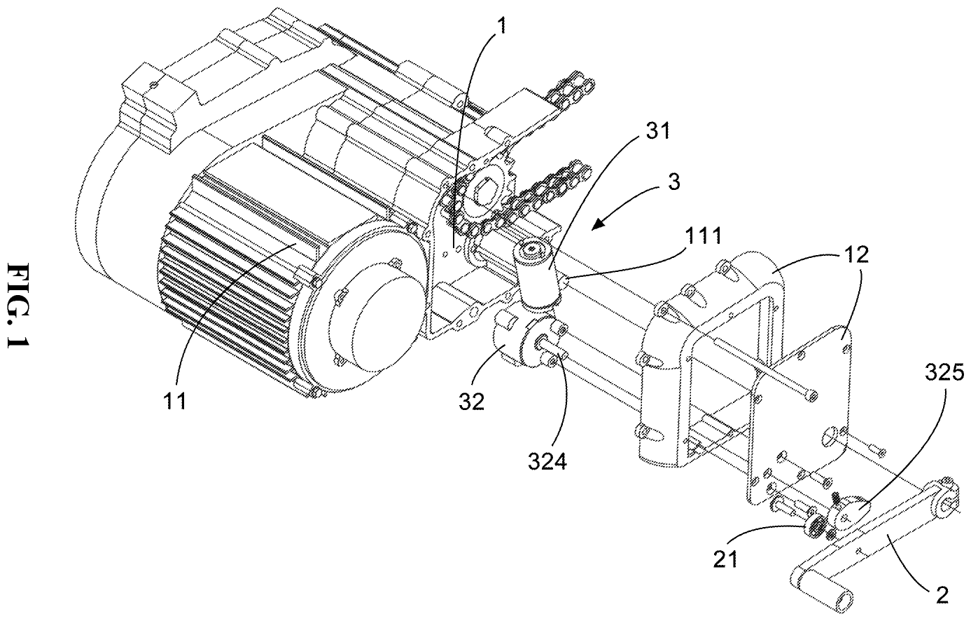

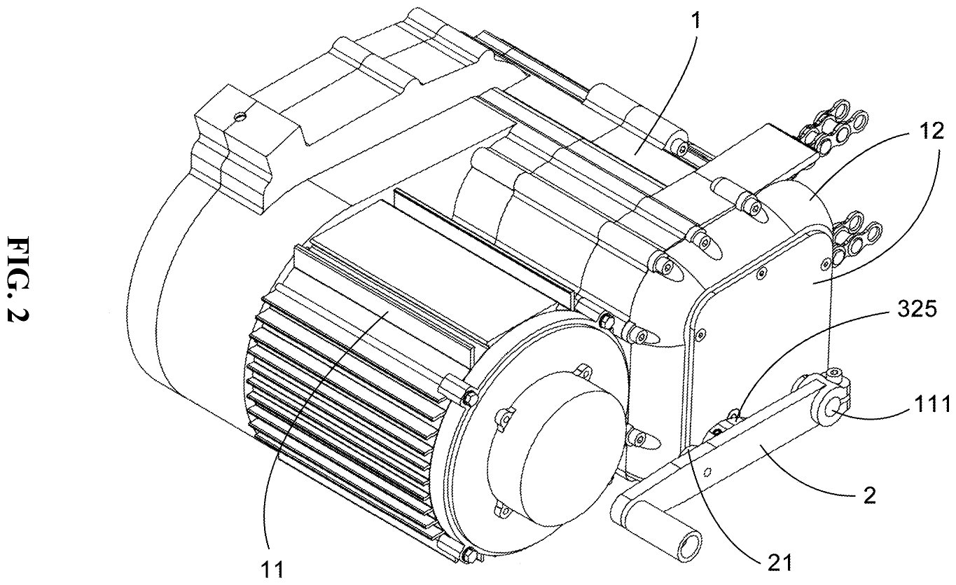

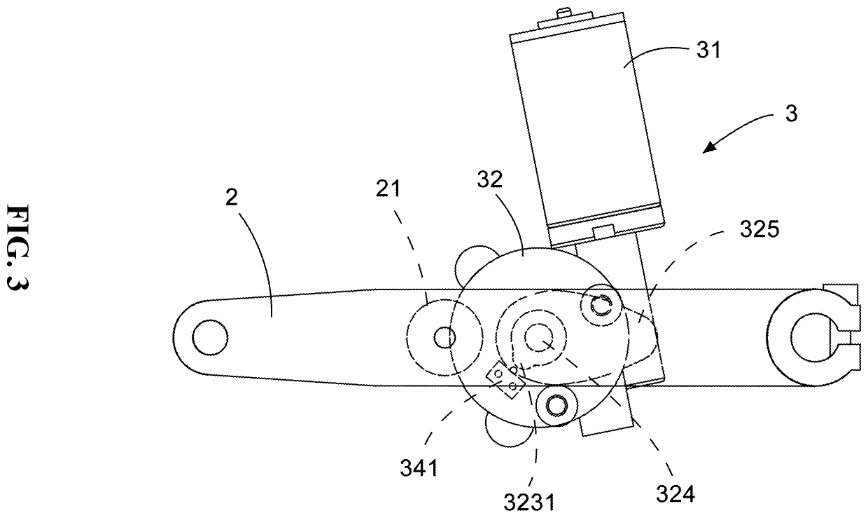

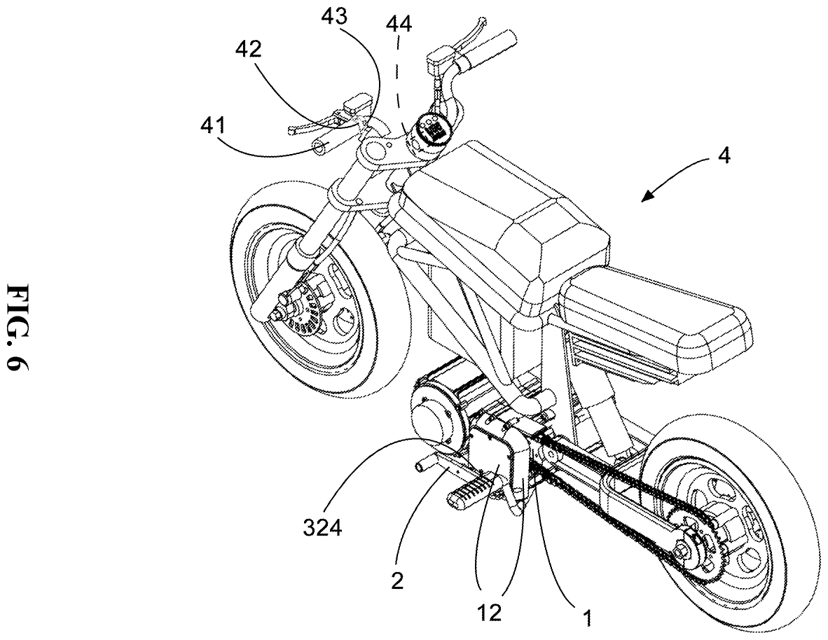

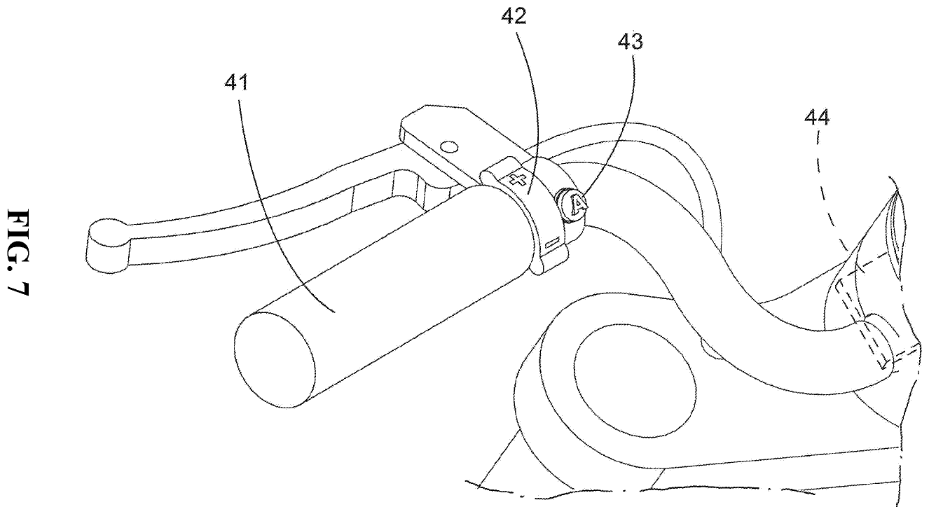

Referring to FIGS. 1-3, the present invention provides an improved vehicle shifting mechanism, which comprises a gearbox 1 driven by a main power motor 11, a gearshift lever 2 and a shift drive unit 3. The gearshift lever 2 is located on the gearshift shaft 111 of the gearbox 1. The shift drive unit 3 is arranged on one side of described gearshift lever 2. Through the electrical connection between the control switch 42 located beside the grip 41 of the vehicle 4 and the shift drive unit 3, the operation of controlling the forward or reverse gear (as shown in FIGS. 6 and 7) is carried out, so that the shift drive unit 3 drives the gearshift lever 2 to produce the action of pushing down the gear or pushing up the gear. And through an automatic shift switch 43 located beside the grip 41 of the vehicle 4, and in cooperation with a main driving control processor 44, when the automatic shift switch 43 is turned on to be in automatic shift mode, the main driving control processor 44 will receive the data of the main power motor 11 or the engine speed and torque load to activate the shift drive unit 3 at the optimum time point to drive the gearshift lever 2 to generate a fully automatic downshifting gear or an upshifting gear and a neutral gear control. It avoids the complicated shifting action of the driver to step on the gearshift lever 2 with his feet to advance or hook the gearshift lever 2 with the instep to reverse, thereby achieving the purpose of changing gears more conveniently, improving driving safety and saving energy when driving.

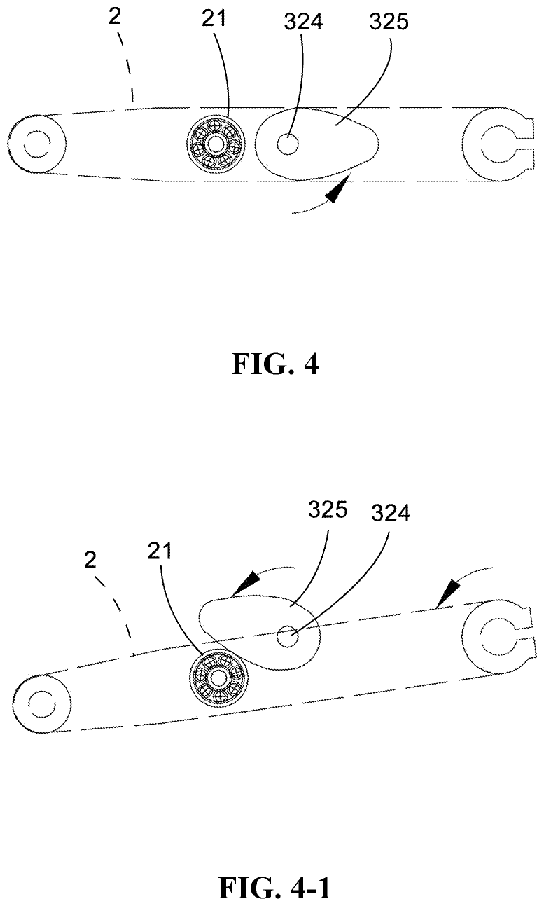

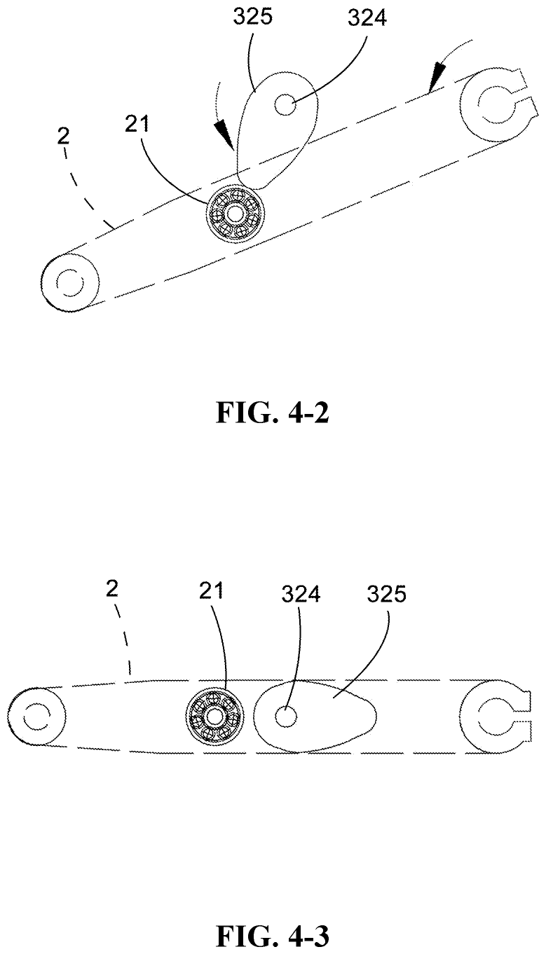

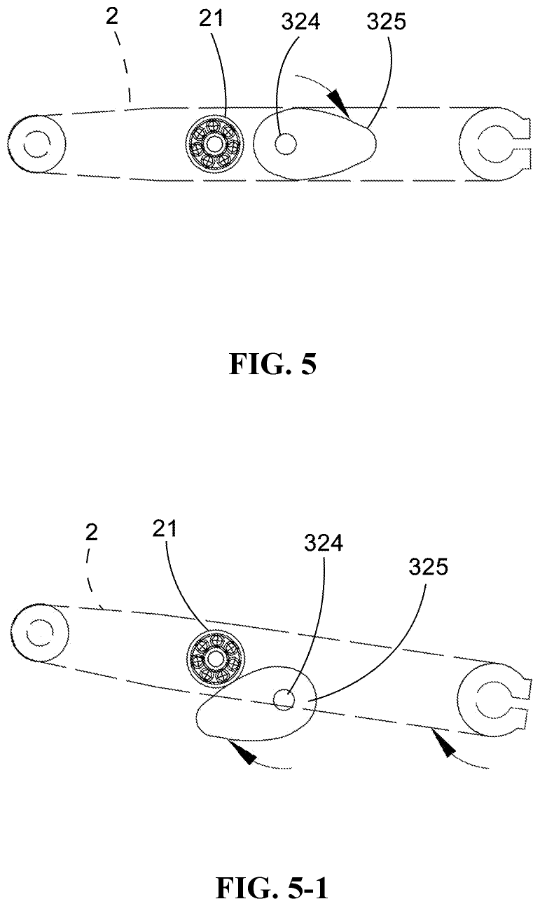

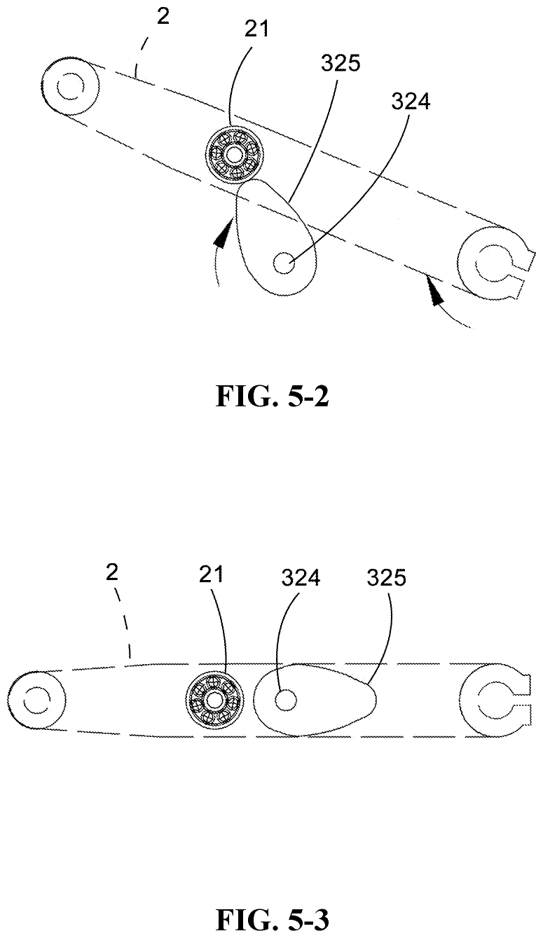

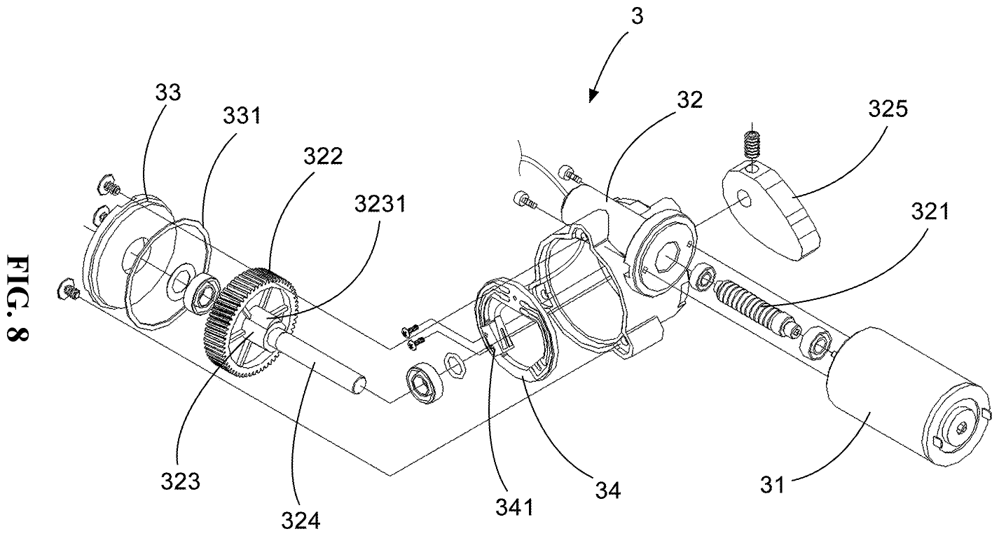

Please refer to FIG. 8, wherein the shift drive unit 3 comprises a motor 31, a speed reducer and a cam 325. The motor 31 is set at the input end of the speed reducer. The casing 32 of the speed reducer is provided with a first reduction gear 321 and a second reduction gear 322. The motor 31 drives the first reduction gear 321. The second reduction gear 322 has a power take-off shaft 324 extending out from one side of the casing 32. A circuit board 34 with a micro-motion sensing element 341 is assembled on one side of the casing 32, and the second reduction gear 322 and the circuit board 34 are enclosed in the casing 32 by a side cover 33 and a gasket 331. The cam 325 is provided on the power take-off shaft 324 of the second reduction gear 322. When the motor 31 drives the first reduction gear 321 and the second reduction gear 322 to rotate, it also drives the cam 325 disposed on the second reduction gear 322 power take-off shaft 324 to rotate forward or reverse synchronously. By means of the magnetic element 3231 or the convex part on the second reduction gear 322 hub 323 and the micro-motion sensing element 341 to generate sensing or pressure contact, and then after the cam 325 rotates forward or reverse 360 degrees, the motor 31 is stopped to make the cam 325 stop at the original position. When pressing the control switch 42 “+” next to the grip 41 of the vehicle 4 once, the control switch 42 will control the movement of the shift drive unit 3 and drive the cam 325 to reverse 360 degrees once. When the cam 325 rotates, push the roller 21 arranged on the inner side of the gearshift lever 2 to lower the gearshift lever 2, and then complete the action of pressing the gearshift lever 2 to advance the gear once (as shown in FIGS. 4 to 4-3). Conversely, when pressing the “−” of the control switch 42 next to the vehicle 4 grip 41 once, the control switch 42 will control the shift drive unit 3 to act and drive the cam 325 to rotate forward 360 degrees once. When the cam 325 rotates, push the roller 21 arranged on the inner side of the gearshift lever 2 to push the gearshift lever 2 upward, and then complete the action of pushing the gearshift lever 2 back once (as shown in FIGS. 5 to 5-3). When the automatic shift switch 43 is pressed to be in the automatic shift mode, the shift drive unit 3 drives the gearshift lever 2 to produce automatic control of pushing down the forward gear or pushing up the reverse gear and neutral.

The shift drive unit 3 is locked to the gearbox side cover 12 for easy maintenance or replacement of the shift drive unit 3.

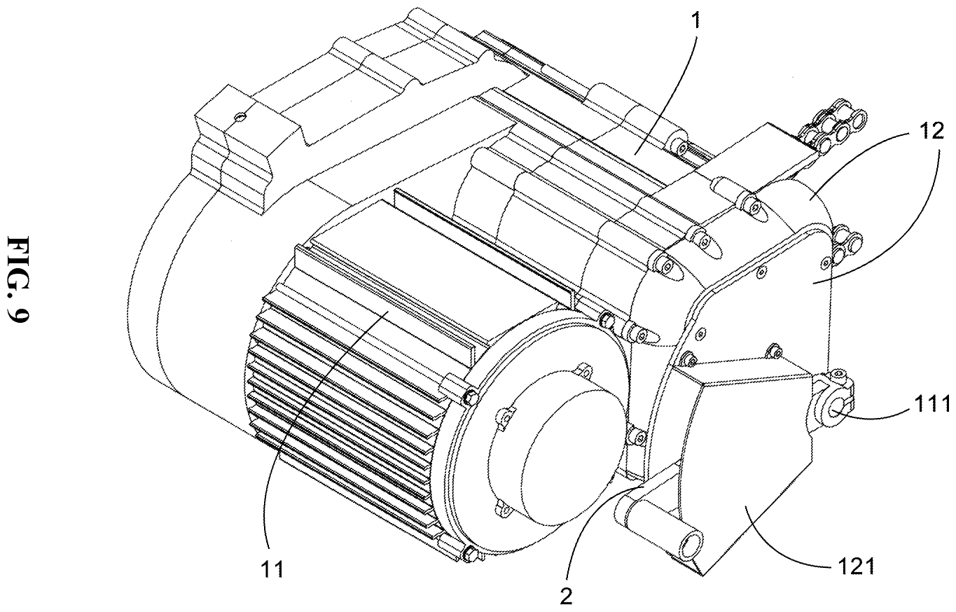

The micro-motion sensing element 341 can be a sensing chip or a micro switch. Besides the side cover 12 of the gearbox, there is an outer cover 121 (as shown in FIG. 9), which has the effect of beauty and anti-fouling.

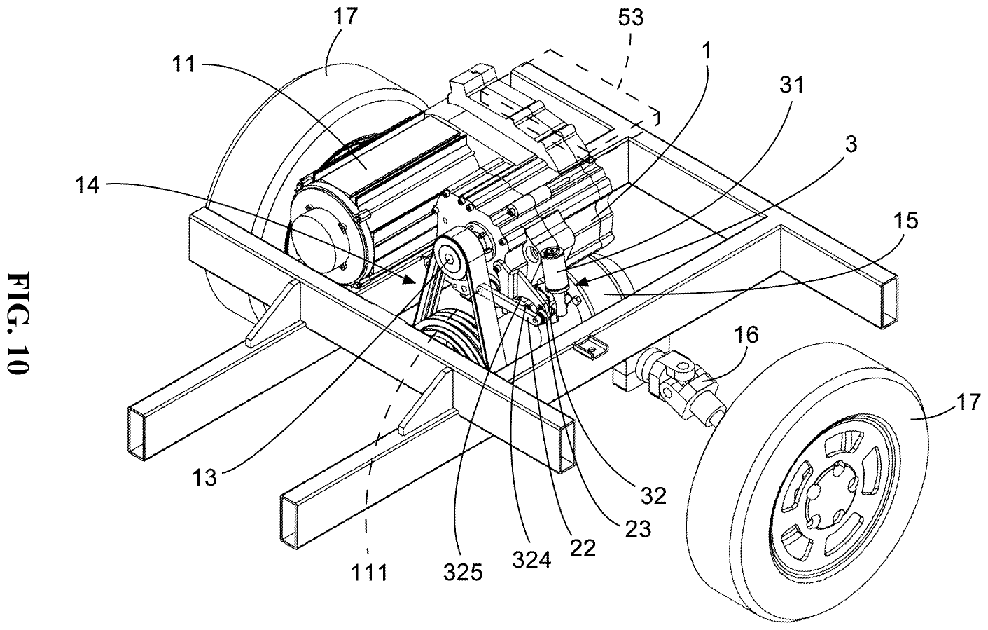

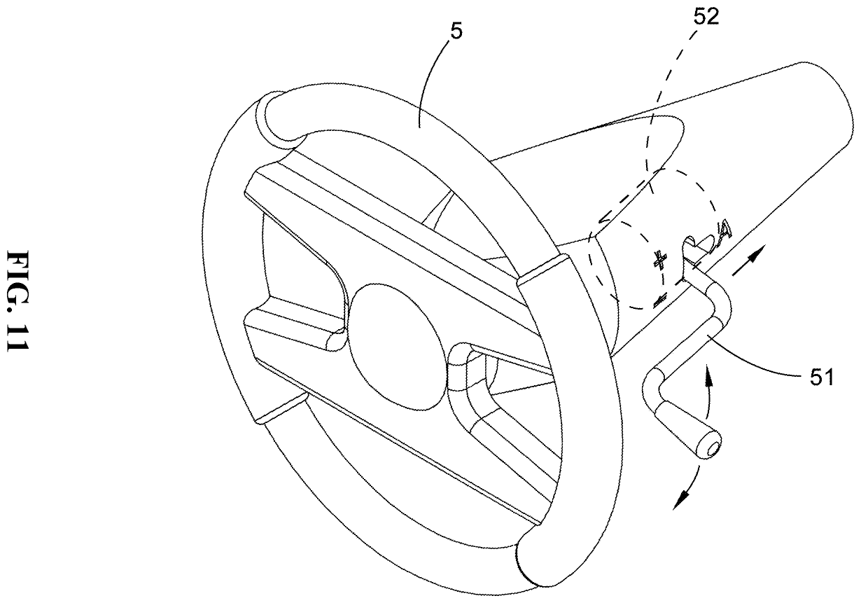

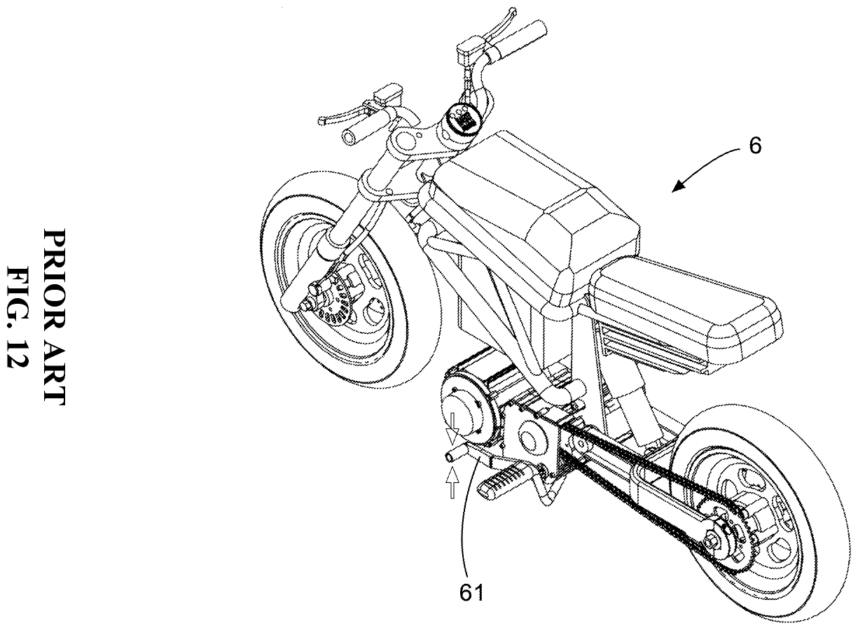

Please refer to FIG. 10 and FIG. 11 again, which are an embodiment of the present invention when applied to an electric vehicle. It comprises a gearbox 1 driven by a main power motor 11, a gearshift lever 22 and a shift drive unit 3. The gearshift lever 22 is located at the gearshift shaft 111 of the gearbox 1. The shift drive unit 3 is located on one side of the gearshift lever 22. Through the gear lever 51 and the control switch 52 located in the steering wheel 5 seat of the electric vehicle or at a suitable position beside the driver's seat, the control switch 52 and the shift drive unit 3 are electrically connected to perform the operation of shifting in or out. The control switch 52 can be controlled by the gear lever 51, or the control switch 52 can also be a push type or a knob type. When the gear lever 51 is moved to the “+” direction of the control switch 52 once or the control switch 52 is pressed “+” once, the control switch 52 will control the shift drive unit 3 to act and drive the cam 325 to reverse 360 degrees once. When the cam 325 rotates, push the roller 23 arranged on the inner side of the gearshift lever 22 to push the gearshift lever 22, and then complete the action of pushing the gearshift lever 22 to advance the gear once. On the contrary, toggle the gear lever 51 to the “−” direction of the control switch 52 once or press the control switch 52 “−” once, the control switch 52 will control the shift drive unit 3 to act and drive the cam 325 to rotate forward 360 degrees once. When the cam 325 rotates, push the roller 23 located on the inner side of the gearshift lever 22 to lower the gearshift lever 22, and then complete the action of pressing the gearshift lever 22 to back down once. When the gear lever 51 is moved to the “A” direction of the control switch 52 once or the control switch 52 “A” is pressed once to turn on the automatic shift control mode, the main driving control processor 53 of the electric vehicle will receive the data of the rotational speed and the torque load to activate the shift drive unit 3 at the optimum time point to drive the cam 325 to push the gearshift lever 22 to produce an automatic control of up-propelled gear or down-pressed reverse gear and neutral gear, so as to achieve the purpose of automatic gear shifting. There is a differential gear under the gearbox 1. Between the speed output shaft 13 of the gearbox 1 and the differential gear 15, a pulley set 14 is arranged to drive the transmission shaft 16 to drive the wheels 17 to rotate through the differential gear 15.

To sum up, the present invention has the effect of improving the safety of driving without the need to step on or hook back the gearshift lever for shifting the gears. Thus, the effect of driving safety is improved.

What the invention claimed is:

1. A vehicle shifting mechanism comprising a gearbox, a gearshift lever and a shift drive unit, said gearbox being driven by a main power motor and comprising a gearshift shaft, said gearshift lever being located on said gearshift shaft of said gearbox, said shift drive unit being arranged on one side of said gearshift lever, wherein through the electrical connection between a control switch located beside a grip of a vehicle and said shift drive unit, the operation of controlling the forward or reverse gear is carried out, so that said shift drive unit drives said gearshift lever to produce the action of pushing down the gear or pushing up the gear; through an automatic shift switch located beside said grip of said vehicle, and in cooperation with a main driving control processor, when said automatic shift switch is turned on to be in automatic shift mode, said main driving control processor receives the data of said main power motor or the engine speed and torque load of said vehicle to activate said shift drive unit at the optimum time point to drive said gearshift lever to generate a fully automatic downshifting gear or an upshifting gear and a neutral gear control, thereby achieving the purpose of changing gears more conveniently, improving driving safety and saving energy when driving.

2. The vehicle shifting mechanism as claimed in claim 1, wherein said shift drive unit comprises a motor, a speed reducer and a cam, said motor being set at an input end of said speed reducer, said speed reducer comprising a casing and a first reduction gear and a second reduction gear provided in said casing, said motor being used to drive said first reduction gear, said second reduction gear comprising a power take-off shaft extending out from one side of said casing, a circuit board with a micro-motion sensing element being assembled on one side of said casing, and said second reduction gear and said circuit board being enclosed in said casing by a side cover and a gasket, said cam being provided on said power take-off shaft of said second reduction gear, wherein when said motor drives said first reduction gear and said second reduction gear to rotate, said motor also drives said cam to rotate forward or reverse 360 degrees to drive said gearshift lever to produce the action of pressing down the forward gear or pushing up the reverse gear;
by means of said magnetic element or a convex part on a hub of said second reduction gear and said micro-motion sensing element to generate sensing or pressure contact, and then after said cam rotates forward or reverse 360 degrees, said motor is stopped to make said cam stop at the original position.

3. The vehicle shifting mechanism as claimed in claim 1, wherein said shift drive unit is locked to a side cover of said gearbox for easy maintenance or replacement of said shift drive unit.

4. The vehicle shifting mechanism as claimed in claim 2, wherein said micro-motion sensing element is selectively a sensing chip or a micro switch.

5. A vehicle shifting mechanism comprising a gearbox, a gearshift lever and a shift drive unit, said gearbox being driven by a main power motor and comprising a gearshift shaft, said gearshift lever being located on said gearshift shaft of said gearbox, said shift drive unit being located on one side of said gearshift lever, wherein through a gear lever and a control switch located in a steering wheel seat of an electric vehicle or at a suitable position beside the driver's seat, said control switch and said shift drive unit are electrically connected to perform the operation of shifting in or out; when said gear lever is moved to “+” direction of said control switch once or said control switch is pressed “+” once, said control switch controls said shift drive unit to act and drive said cam to reverse 360 degrees once; when said cam rotates, push a roller arranged on an inner side of said gearshift lever to push said gearshift lever, and then complete the action of pushing said gearshift lever to advance the gear once; on the contrary, toggle said gear lever to “−” direction of said control switch once or press said control switch “−” once, said control switch controls said shift drive unit to act and drive said cam to rotate forward 360 degrees once, and when said cam rotates, push said roller located on the inner side of said gearshift lever to lower said gearshift lever, and then complete the action of pressing the gearshift lever to back down once.

6. The vehicle shifting mechanism as claimed in claim 5, wherein said control switch also includes automatic shift control;
when said gear lever is moved to “A” direction of said control switch once or the control switch “A” is pressed once to turn on the automatic shift control mode, the main driving control processor of the electric vehicle receives the data of the rotational speed and the torque load to activate said shift drive unit at the optimum time point to drive said cam to push said gearshift lever to produce an automatic control of up-propelled gear or down-pressed reverse gear and neutral gear, so as to achieve the purpose of automatic gear shifting.

7. The vehicle shifting mechanism as claimed in claim 5, wherein said shift drive unit comprises a motor, a speed reducer and a cam, said motor being set at an input end of said speed reducer, said speed reducer comprising a casing and a first reduction gear and a second reduction gear provided in said casing, said motor being used to drive said first reduction gear, said second reduction gear comprising a power take-off shaft extending out from one side of said casing, a circuit board with a micro-motion sensing element being assembled on one side of said casing, and said second reduction gear and said circuit board being enclosed in said casing by a side cover and a gasket, said cam being provided on said power take-off shaft of said second reduction gear, wherein when said motor drives said first reduction gear and said second reduction gear to rotate, said motor also drives said cam to rotate forward or reverse 360 degrees to drive said gearshift lever to produce the action of pressing down the forward gear or pushing up the reverse gear;
by means of said magnetic element or a convex part on a hub of said second reduction gear and said micro-motion sensing element to generate sensing or pressure contact, and then after said cam rotates forward or reverse 360 degrees, said motor is stopped to make said cam stop at the original position.

8. The vehicle shifting mechanism as claimed in claim 7, wherein said micro-motion sensing element is selectively a sensing chip or a micro switch.

9. The vehicle shifting mechanism as claimed in claim 5, wherein said control switch is controllable by said gearshift lever, and said control switch is selectable to be a push type or a knob type.

10. The vehicle shifting mechanism as claimed in claim 6, wherein said control switch is controllable by said gearshift lever, and said control switch is selectable to be a push type or a knob type.
